(19) United States
(12) Patent Application Publication
(10) Pub. No.: US 2009/0249556 A1
(43) Pub. Date: Oct. 8, 2009

(54) Compositions for the Flame-Inhibiting Finishing of Fiber Materials

(75) Inventors: Salman Dermeik, Augsburg (DE); Simpert Lüdemann, Bobingen (DE)

Correspondence Address: HUNTSMAN TEXTILE EFFECTS (GERMANY) GMBH;Legal Department, 10003 Woodloch Forest Drive, The Woodlands, TX, 77380, US

(73) Assignee: HUNTSMAN TEXTILE EFFECTS (GERMANY) GMBH, Langweid a, Lech (DE)

(21) Appl. No.: 11/721,730

(22) PCT Filed: Nov. 22, 2005
(86) PCT No.: PCT/EP2005/012452

§ 371 Date: Jun. 14, 2007

(30) Foreign Application Priority Data
Dec. 16, 2004 (EP) 04029751.7

(51) Int. Cl. C09K 21/10; C09K 21/12; D06P 1/642

(52) U.S. Cl. 8/115.66; 252/608; 8/115.51

(57) ABSTRACT

Compositions which can be obtained by a specific process from water, guanidine phosphate, amidosulfonic acid or ammonium sulfamate and ammonium sulfate are described. The compositions are suitable for the flame-inhibiting finishing of fiber materials, in particular of textile fabrics, e.g. those made of polyester.

The invention relates to aqueous compositions which can be prepared by a specific process from water, guanidine phosphate, amidosulfonic acid and ammonium sulfate, it also being possible to use ammonium sulfamate instead of amidosulfonic acid. It also relates to the use of the compositions for the treatment of fiber materials.

It is known to provide various materials, including textile fabrics, with a fire-retardant finish by applying nitrogen- and/or phosphorus-containing products. Thus, for example, U.S. Pat. No. 5,418,282 describes polymer foams and wood particle boards which have a fire-retardant finish. For this purpose, during the manufacture of these articles, compositions which comprise, for example, ammonium phosphate, boric acid and ammonium borate are added in particle form.

U.S. Pat. No. 2,935,471 reveals compositions which comprise a boron compound and an inorganic ammonium salt. The compositions are used for the fire-retardant finishing of cellulose materials.

GB patent specification 1 174 866 describes aqueous solutions which can be used to provide fiber materials comprising cellulose with a fire-retardant finish. The aqueous solutions comprise one or more of the compounds ammonium sulfate, ammonium sulfamate or ammonium imidosulfonate.

U.S. Pat. No. 4,448,841 reveals that textiles can be given a fire-resistant finish by treating them with aqueous compositions which comprise ammonium salts, e.g. ammonium sulfate, ammonium phosphate or ammonium sulfamate.

The aqueous compositions known from the prior art for the fire-retardant finishing of textile fabrics do not have optimum properties with regard to the stability and/or the properties of the fiber materials finished therewith. Particularly in the case of textiles made of polyester, the results obtained with known compositions are not optimal.

The object on which the present invention is based was to develop compositions with which fiber materials in the form of textile fabrics can be provided with a flame-retardant finish and where these fabrics have excellent flame-retardant properties, and where these compositions are especially well-suited for the flame-retardant finishing of fiber materials made of polyester.

The object has been achieved by an aqueous composition which is preparable by the following successive process steps

a) Preparation of a mixture of water and guanidine phosphate, the quantitative ratios being chosen such that the mixture has a phosphorus content in the range from 4.0 to 6.5% by weight.

b) Optional adjustment of the pH of the mixture to a value in the range from 4.5 to 6.5 at 20° C.

c) Addition of ammonium sulfamate or amidosulfonic acid in an amount such that, per 100 g of the mixture obtained after step b), 8 to 12 g of amidosulfonic acid or 9.5 to 15 g of ammonium sulfamate are used, or addition of a mixture of these two products.

d) Optional adjustment of the pH of the resulting mixture to a value in the range from 4.5 to 6.5 at 20° C.

e) Addition of ammonium sulfate in an amount such that, per 100 g of the mixture obtained after step d), 20 to 40 g of ammonium sulfate are used.

If fiber materials are finished with the aqueous compositions according to the invention, then highly effective fire-retardant properties can be attained. The fiber materials are preferably textile fabrics in the form of wovens, knits or nonwovens. Also, particularly in the case of textiles made of polyester fibers it is possible to achieve a highly effective fire-retardant finish whereas many compositions known from the prior art are unsuitable or insufficiently suitable for polyester.

Suitable polyester fibers are, in particular, fibers of polyethylene terephthalate, although compositions according to the invention are also suitable for textiles made of other polyester fibers.

In addition, using compositions according to the invention it is also possible to effectively provide textiles made of cellulose fibers or of mixtures of cellulose fibers and polyester fibers with a fire-retardant finish.

The treatment of fiber materials with compositions according to the invention can take place using equipment and according to methods which are known to the textile finisher. Of suitability, for example, is application by means of a pad mangle and subsequent drying, e.g. at 100 to 130° C. If appropriate, the drying can also be followed by a condensation, e.g. in the temperature range from 130 to 180° C.

Compositions according to the invention can be prepared by the abovementioned process steps. These will now be described in more detail.

### Step a):

In this process step, a mixture of water and guanidine phosphate is prepared. For this, it is possible to use secondary guanidine phosphate which is formed from 2 mol of guanidine and 1 mol of orthophosphoric acid, or primary guanidine phosphate which is formed from 1 mol of guanidine and 1 mol of orthophosphoric acid. It is of course also possible to use a mixture of primary and secondary guanidine phosphate.

The mixture in step a) can, if appropriate, be prepared at elevated temperature, e.g. in the range from 30° C. to 70° C., and with stirring.

In step a), the quantitative ratios of water and guanidine phosphate are to be chosen so that the resulting mixture has a phosphorus content (calculated as P) in the range from 4.0 to 6.5% by weight. For example, it is possible to prepare a mixture which comprises 35% by weight of secondary guanidine phosphate.

### Step b):

If the mixture obtained after step a) has a pH at 20° C. in the range from 4.5 to 6.5, then step b) is not carried out. If, on the other hand, the pH of the mixture after carrying out step a) is outside of the specified range, then step b) has to be carried out. This step consists in adjusting the pH to a value within the specified range.

Orthophosphoric acid is well-suited for this adjustment of the pH if the pH of the mixture after carrying out step a) is higher than 6.5. The orthophosphoric acid can be used for this purpose, for example, as a 50 to 90% strength aqueous solution.

### Step c):

In step c), 8 to 12 g of amidosulfonic acid H₂N—SO₃H or 9.5 to 15 g of ammonium sulfamate NH₄^{⊕}H₂N—SO₃^{⊖}are added to the mixture obtained after carrying out step a) and optionally step b) per 100 g of the mixture. It is also possible to add a mixture of these two products. In this case, an amount of this mixture is used which comprises

$$\frac{x}{100} * ( 8 to 12 ) g and \frac{y}{100} * ( 9.5 to 15 ) g$$

of ammonium sulfamate.

Here, x indicates how much percent by weight of amidosulfonic acid the mixture comprises, and y indicates how much percent by weight of ammonium sulfamate the mixture comprises. All of the specified amounts of amidosulfonic acid and ammonium sulfamate refer to solid, anhydrous products, although it is optionally also possible to use aqueous solutions of amidosulfonic acid or ammonium sulfamate instead of solid products in step c). The addition of amidosulfonic acid and ammonium sulfamate serves to achieve fire-retardant properties coupled with a soft handle of textiles.

### Step d):

If the mixture obtained after carrying out step c) has a pH in the range from 4.5 to 6.5 at 20° C., then step d) is not carried out. If the pH is outside of this range, then step d) has to be carried out, namely an adjustment of the pH to a value within the range from 4.5 to 6.5 at 20° C. If the pH after carrying out step c) is lower than 4.5, then it is preferably corrected in step d) by adding ammonia. For this purpose, gaseous NH₃ can be introduced into the mixture. However, it is more advantageous to add an aqueous NH₃ solution, e.g. with a concentration of from 20 to 25% by weight.

### Step e):

In step e), ammonium sulfate is added to the mixture obtained after carrying out step c) and optionally step d). In this step, 20 to 40 g of ammonium sulfate are used per 100 g of the mixture. These amounts refer to solid, anhydrous ammonium sulfate. This salt may be added in solid form or in the form of an aqueous solution of the mixture.

The addition of ammonium sulfate exerts an advantageous influence on the fire-retardant properties of textile fiber materials which have been treated with compositions according to the prior art, in particular textile fabrics made of polyester fibers.

After adding ammonium sulfate, the mixture obtained can, if desired, be diluted with water.

At the end of step e), the resulting mixture is preferably stirred, optionally at elevated temperature, until a clear solution is formed.

The composition obtained after step e) can, optionally following dilution with water, be used for the fire-retardant finishing of textile fabrics. It can, however, also be added prior to the use of other products which are known to the person skilled in the art for textile finishing. However, during their use, compositions according to the invention preferably comprise no other nitrogen-or phosphorus-containing products apart from those mentioned above, with the exception of urea. In addition, it is preferred if they comprise neither boron compounds nor halogen compounds.

In a number of cases, it may be advantageous if, after carrying out step e), one or more other products are also added to the resulting mixture. These products are chosen from sodium acetate, urea and sodium hydroxide. Preference is given to using the following amounts, if the product in question is used at all, per 100 g of the mixture obtained after step e):

0.7 to 1.3 g of sodium acetate

0.7 to 1.3 g of urea, and

sodium hydroxide in an amount such that the resulting composition has a pH in the range from 5 to 6.5 at 20° C. These amounts refer to solid, anhydrous products, although the products can be used in solid, pure form or in the form of aqueous solutions. It is advantageous not to add sodium hydroxide to the composition before the addition of sodium acetate or urea, but only afterwards.

The invention will be illustrated below by working examples.

### EXAMPLE 1

Preparation of a composition according to the invention.

200 kg of secondary guanidine phosphate (prepared from H₃PO₄ and guanidine carbonate

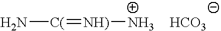

in the molar ratio 1:2) are added to 375 kg of demineralized water. The addition of approximately 60 kg of 80% strength orthophosphoric acid gives a clear solution of pH 5.5. 60 kg of amidosulfonic acid (H₂N—SO₃H) are added thereto. The pH is then adjusted to a value of 5.5 using 46 kg of 25% strength aqueous ammonia solution. After adding 200 kg of solid ammonium sulfate and stirring, a clear solution is obtained. This is diluted with 86 kg of water. 11 kg of sodium acetate and 11 kg of urea are then added and the mixture is stirred again until a clear solution is formed. A pH of approximately 5.5 is established by adding aqueous sodium hydroxide solution.

### EXAMPLE 2

The solution obtained according to Example 1 is filtered in order to remove residues of impurities.

Textile fabrics made of fiber materials are then finished.

### EXAMPLE 2a

### (According to the Invention)

Polyester fabric with an m² weight of about 135 g is treated in an aqueous liquor which consists of 200 g of the composition prepared according to Example 1 per liter in a pad mangle such that a liquor pick-up of approximately 75%, based on the textile weight results. The fabric is dried for 10 minutes at 110° C.

### EXAMPLE 2b

### (According to the Invention)

Polyester fabric with an m² weight of about 270 g is treated in an aqueous liquor which consists of 200 g of the composition prepared according to Example 1 per liter in a pad mangle such that a liquor pick-up of approximately 110%, based on the textile weight, results. The fabric is dried for 10 minutes at 110° C.

### EXAMPLE 2c and 2d

### (Comparative Examples Not In Accordance with the Invention)

Examples 2a and 2b are repeated but using a comparison composition instead of the composition according to the invention as in Example 1. In other respects, Example 2c) corresponds to Example 2a) and Example 2d) corresponds to Example 2b).

The comparison composition is a known fire-retardant composition in the form of an aqueous solution which comprises approximately 30% by weight of ammonium sulfamate, 5% by weight of ammonium salt of an orthophosphoric methyl ester, 2% by weight of urea and 6% by weight of borax. It comprises neither guanidine phosphate nor ammonium sulfate.

In accordance with the methods described in DIN 54336, edition from November 1986, the burning time, the glowing time and the tear length (=degree of destruction) are determined on the four fabric samples from Examples 2a) to d). The results are shown in the table below.

### TABLE

Flaming time 3 sec:

| | Example 2a) | Example 2c) |
|---|---|---|
| Burning time sec | 0 | 19 |
| Glowing time sec | 0 | 0 |
| Tear length mm | 30 | 60 |

Flaming time 15 sec:

| | Example 2a) | Example 2c) |
|---|---|---|
| Burning time sec | 0 | 15 |
| Glowing time sec | 0 | 0 |
| Tear length mm | 100 | 145 |

Flaming time 3 sec:

| | Example 2b) | Example 2d) |
|---|---|---|
| Burning time sec | 3 | 16 |
| Glowing time sec | 0 | 0 |
| Tear length mm | 55 | 80 |

Flaming time 15 sec:

| | Example 2b) | Example 2d) |
|---|---|---|
| Burning time sec | 0 | 0 |
| Glowing time sec | 0 | 0 |
| Tear length mm | 100 | 120 |

It is evident from these results that the Examples 2a) and 2b) according to the invention lead to better results than the comparison Examples 2c) and 2d).

1. An aqueous composition preparable by the following successive process steps
a) Preparation of a mixture of water and guanidine phosphate, the quantitative ratios being chosen such that the mixture has a phosphorus content in the range from 4.0 to 6.5% by weight.
b) Optional adjustment of the pH of the mixture to a value in the range from 4.5 to 6.5 at 20° C.
c) Addition of ammonium sulfamate or amidosulfonic acid in an amount such that, per 100 g of the mixture obtained after step b), 8 to 12 g of amidosulfonic acid or 9.5 to 15 g of ammonium sulfamate are used, or addition of a mixture of these two products.
d) Optional adjustment of the pH of the resulting mixture to a value in the range from 4.5 to 6.5 at 20° C.
e) Addition of ammonium sulfate in an amount such that, per 100 g of the mixture obtained after step d), 20 to 40 g of ammonium sulfate are used.

2. The composition as claimed in claim 1, characterized in that after step e) a further step 1) is carried out, where, in step f), per 100 g of the mixture obtained after step e),
0.7 to 1.3 g of sodium acetate and/or
0.7 to 1.3 g of urea and/or
sodium hydroxide are added to the mixture in an amount such that the resulting mixture has a pH at 20° C. in the range from 5 to 6.5.

3. The composition as claimed in claim 1, characterized in that, in step b), the pH is adjusted by adding phosphoric acid.

4. The composition as claimed in claim 1, characterized in that, in step d), the pH is adjusted by adding aqueous ammonia solution.

5-7. (canceled)

8. A method of providing a fiber material with a fire-retardant finish comprising applying an aqueous composition according to claim 1 to the fiber material.

9. The method as claimed in claim 8, characterized in that the fiber material is a textile fabric in the form of a woven, knit or nonwoven.

10. The method as claimed in claim 8, characterized in that the fiber material consists of polyester fibers.
